(19) United States
(12) Patent Application Publication
(10) Pub. No.: US 2026/0046455 A1
(43) Pub. Date: Feb. 12, 2026

(54) COMPUTER VISION MODEL PERFORMANCE MONITORING FOR DATA STREAMING SYSTEMS AND APPLICATIONS

(71) Applicant: NVIDIA Corporation, Santa Clara, CA (US)

(72) Inventors: Swapnil Jagdish RATHI, Pune (IN); Bhushan RUPDE, Pune (IN); Chetan SETHI, Pune (IN); Zheng LIU, Los Altos, CA (US); Kaustubh PURANDARE, San Jose, CA (US)

(73) Assignee: NVIDIA Corporation, Santa Clara, CA (US)

(21) Appl. No.: 18/795,659

(22) Filed: Aug. 6, 2024

(51) Int. Cl. H04N 19/70; H04N 19/172; H04N 19/20

(52) U.S. Cl. CPC H04N 19/70; H04N 19/172; H04N 19/20

(57) ABSTRACT

Various examples, systems, and methods are disclosed relating to computing systems for performance monitoring of computer vision models in data streaming systems and applications. A first computing system can encode video input and embed reference characteristics (e.g., ground truth data) into encoded representations of image frames. The first computing system can encode the video and embed the reference characteristics using an encoder and an injector system, storing the encoded data. A second computing system can receive the encoded video, decode it, and/or extract the reference characteristics using an extractor system. The second computing system can apply vision models to generate inference data, track objects across frames, and/or evaluate model performance. These operations can be performed without frequent file access, improving efficiency and accuracy in evaluating vision model performance under varying network conditions.

### BACKGROUND

Evaluating the performance of vision models in streaming applications presents challenges. Reference data, which can be used for validating model accuracy, is traditionally stored separately from the video frames, leading to inefficiencies and increased computational demands. This separation requires frequent file access to retrieve reference data, which is resource-intensive and prone to errors, especially under network conditions such as frame drops and packet corruptions. The inherent technical difficulty in consistently associating reference data with corresponding video frames further complicates the evaluation process. These challenges affect the effectiveness of systems in assessing the performance of vision models, impacting the accuracy and efficiency of monitoring processes in real-time or near real-time environments.

### SUMMARY

Implementations of the present disclosure relate to performance monitoring of computer vision models in data streaming systems and applications. In contrast to conventional systems, which exhibit limitations in efficiently associating ground truth data with image frames under varying network conditions, systems and methods described herein can address these limitations through integrated encoding and decoding techniques. This implementation provides more accurate and resource-efficient evaluation of computer vision model performance. For example, the systems and methods can embed reference characteristics of objects into frames as messages or data structures, facilitating access during decoding and analysis. Furthermore, by using embedded reference characteristics and reducing or eliminating the need for frequent file access, the systems and methods can maintain reliable performance monitoring even in the presence of frame drops and packet corruptions. This provides improved systems and methods for evaluating and validating computer vision models across diverse streaming scenarios.

At least one implementation relates to one or more processors. The one or more processors can include one or more circuits. The one or more circuits can extract, from an encoded representation of an image frame, the image frame and an indication of a reference characteristic of one or more objects represented by the image frame. The one or more circuits can apply the image frame as input to one or more vision models to cause the one or more vision models to generate inference data regarding the one or more objects represented by the image frame. The one or more circuits can determine a metric of operation of the one or more vision models based at least on the inference data and the reference characteristic.

In some implementations, the one or more circuits can receive the encoded representation as at least one of (i) a stream of image data or (ii) compressed video data. In some implementations, the one or more vision models can include at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame. In some implementations, the one or more circuits can determine the metric of operation based on comparing the inference data with the reference characteristic. In some implementations, the one or more circuits can at least one of (i) assign a flag to one or more parameters of the one or more vision models, the flag corresponding to the metric, or (ii) update the one or more parameters based at least on the metric.

In some implementations, the one or more circuits can generate the encoded representation of the image frame using an encoder. In some implementations, the encoder can be configured to insert the indication of the reference characteristic into the encoded representation. In some implementations, the encoder can be configured to insert the indication of the reference characteristic as a supplemental enhancement information (SEI) message within the encoded representation of the image frame, and wherein the indication of the reference characteristic corresponds to ground truth (GT) data.

In some implementations, inserting the GT data can include embedding the GT data into the image frame of a plurality of image frames of a stream of image data or compressed video data, and wherein the GT data includes at least one of one or more bounding boxes, one or more class labels, or one or more object identifiers (IDs). In some implementations, the encoded representation can be received from a real-time stream. In some implementations, extracting the indication of the reference characteristic can include extracting the SEI message including the GT data and storing the GT data as metadata in a buffer corresponding with an extracted representation of the image frame. In some implementations, applying the image frame as the input to the one or more vision models can include identifying the metadata in the buffer.

At least one implementation relates a system including one or more processors to execute operations. The one or more processors can execute operations to extract, from an encoded representation of an image frame, the image frame and an indication of a reference characteristic of one or more objects represented by the image frame. The one or more processors can execute operations to apply the image frame as input to one or more vision models to cause the one or more vision models to generate inference data regarding the one or more objects represented by the image frame. The one or more processors can execute operations to determine a metric of operation of the one or more vision models based at least on the inference data and the reference characteristic.

In some implementations, the one or more processors executing the operations can receive the encoded representation as at least one of (i) a stream of image data or (ii) compressed video data. In some implementations, the one or more vision models can include at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame. In some implementations, the one or more processors executing the operations can determine the metric of operation based on comparing the inference data with the reference characteristic, and wherein the one or more processors executing the operations are to at least one of (i) assign a flag to one or more parameters of the one or more vision models, the flag corresponding to the metric, or (ii) update the one or more parameters based at least on the metric.

In some implementations, the one or more processors executing the operations can generate the encoded representation of the image frame using an encoder. In some implementations, the encoder can be configured to insert the indication of the reference characteristic into the encoded representation. In some implementations, the encoder can be configured to insert the indication of the reference characteristic as a supplemental enhancement information (SEI) message within the encoded representation of the image frame. In some implementations, the indication of the reference characteristic can correspond to ground truth (GT) data. In some implementations, inserting the GT data can include embedding the GT data into the image frame of a plurality of image frames of a stream of image data or compressed video data. In some implementations, GT data can include at least one of one or more bounding boxes, one or more class labels, or one or more object identifiers (IDs).

In some implementations, the encoded representation can be received from a real-time stream. In some implementations, extracting the indication of the reference characteristic can include extracting the SEI message including the GT data and storing the GT data as metadata in a buffer corresponding with an extracted representation of the image frame. In some implementations, applying the image frame as the input to the one or more vision models can include identifying the metadata in the buffer.

At least one implementation relates to a method. The method can include extracting, using one or more processors from an encoded representation of an image frame, the image frame and an indication of a reference characteristic of one or more objects represented by the image frame. The method can include applying, using the one or more processors, the image frame as input to one or more vision models to cause the one or more vision models to generate inference data regarding the one or more objects represented by the image frame. The method can include determining, using the one or more processors, a metric of operation of the one or more vision models based at least on the inference data and the reference characteristic.

In some implementations, the method can include receiving, using the one or more processors, the encoded representation as at least one of (i) a stream of image data or (ii) compressed video data. In some implementations, the one or more vision models can include at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame.

The processors, systems, and/or methods described herein can be implemented by or included in at least one of a system for generating synthetic data; a system for performing simulation operations; a system for performing digital twin operations; a system for performing conversational AI operations; a system for performing deep learning operations; a system for performing collaborative content creation for 3D assets; a system including one or more large language models (LLMs); a system including one or more vision language models (VLMs); a system for performing light transport simulation; a system incorporating one or more virtual machines (VMs); a system implemented using an edge device; a system implemented using a robot; a control system for an autonomous or semi-autonomous machine; a perception system for an autonomous or semi-autonomous machine; a system implemented at least partially in a data center; or a system implemented at least partially using cloud computing resources.

### BRIEF DESCRIPTION OF THE DRAWINGS

The present systems and methods for performance monitoring of computer vision models are described in detail below with reference to the attached drawing figures, wherein:

FIG. 1 is a block diagram of an example system to perform operations including injecting and extracting indications of characteristics of one or more objects represented by image frames, in accordance with some embodiments of the present disclosure;

FIG. 2 depicts a block diagram of an example system showing how indications of characteristics of one or more objects are injected and extracted, in accordance with some embodiments of the present disclosure;

FIG. 3 is a flow diagram of an example of a method for performance monitoring of computer vision models, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for performance monitoring of computer vision models, including computer vision models (also referred herein as vision models) that are implemented in data streaming systems and applications. These vision models can be used in various applications for performing computer vision operations including but not limited to object detection and tracking. These vision models (also referred herein as computer vision models) can include, for example, machine learning and/or artificial intelligence models that process image and/or video data to generate outputs regarding the image and/or video data.

To test the performance of vision models, it can be useful to evaluate an output of a vision model relative to a ground truth, such as a ground truth associated with images provided to the vision model. The performance testing can include testing the accuracy of the vision model in correctly identifying, for example, text, scenes, gestures, activities, anomalies, features, objects, and/or characteristics in images. In various applications (including but not limited to applications in which the images provided to the vision model are received via network communications, such as by streaming of the images and/or video, as well as applications in which video encoding/decoding is performed), it can be challenging to correctly associate a given image frame with corresponding ground truth data. For example, in order to test the accuracy of the vision model under conditions such as frame drop or packet corruption, it can be challenging to associate the ground truth data with the corresponding image frames; associating the frame with the ground truth data can require complex logic, which can be error-prone under varying network conditions. While some techniques store the ground truth data in a file for retrieval downstream of the network communications, accessing the ground truth data from the file can require frequent file input/output operations, which can increase computational and/or processing resource demands for performance testing, and which can limit scalability of testing.

Systems and methods in accordance with the present disclosure can allow for performance testing of vision models in a manner that can avoid errors during the testing process and/or reduce processing resource demands for accessing ground truth data for performing the testing. For example, a reference data element (e.g., ground truth information) can be assigned to or otherwise associated with an image frame. The reference data element can be assigned by an encoder of the image frame, such as by using a data element (e.g., metadata, header portion, etc.) for encoding and/or communication of the image frame, such as a supplemental enhancement information (SEI) data element. The encoded image frame (e.g., having the assigned reference data element) can be provided to a decoder (e.g., via a wireless network connection). The decoder can decode the encoded image frame to retrieve the image frame and the reference data element, which was previously assigned to the image frame (e.g., attached as metadata to the image frame). One or more computer vision models can generate output data (e.g., inference data, such as object data and/or features) regarding the image data. The decoder may be configured (e.g., programmed) to detect or recognize the presence of the reference data element in the encoded image frame, and/or extract the reference data element from the encoded image frame.

The performance of the one or more computer vision models can depend on various factors associated with one or more aspects of a processing pipeline up to the operation of the one or more computer vision models. A metric for the performance of the one or more computer vision models, individually or in combination, can be determined based at least on output data and an indication of a predetermined characteristic. By determining the metric using the reference data element that is assigned to the encoded image frame, processor usage (e.g., for file input/output) can be reduced, and the need for complex logic for correctly mapping reference data to corresponding image frames can be obviated, reducing errors associated with the testing process.

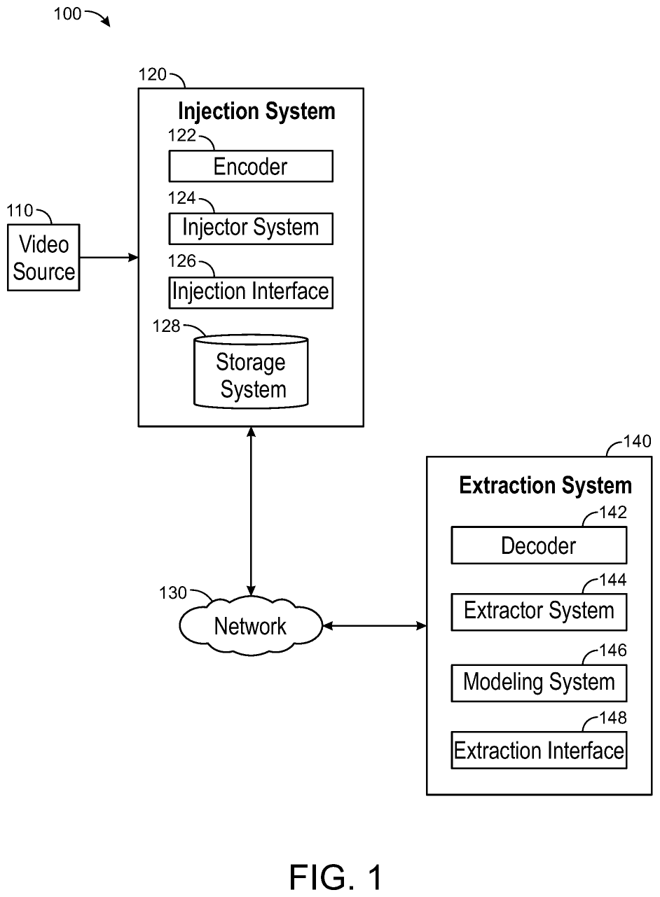

With reference to FIG. 1, an example computing environment including a system 100 for injecting and extracting indications of characteristics of one or more objects represented by image frames is shown, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

The system 100 is shown as including a video source(s) 110, an injection system(s) 120, at least one network 130, and an extraction system(s) 140. The network 130 can include computer networks such as the Internet, local, wide, metro, or other area networks, intranets, satellite networks, other computer networks such as voice or data mobile phone communication networks, and combinations thereof. An injection interface 126 of the injection system 120 can communicate via the network 130, for instance, with the extraction system 140. The network 130 can be any form of computer network that can relay information between the video source 110, the injection system 120, the extraction system 140, and one or more information sources, such as web servers, external databases, or external computing systems, amongst others.

In some implementations, the network 130 can include the Internet and/or other types of data networks, such as a local area network (LAN), a wide area network (WAN), a cellular network, a satellite network, and/or other types of data networks. The network 130 can also include any number of computing devices (e.g., computers, servers, routers, network switches, etc.) that are configured to receive and/or transmit data within the network 130. The network 130 can further include any number of hardwired and/or wireless connections.

As described herein, conventional approaches to evaluating vision artificial intelligence (AI) model accuracy in streaming scenarios lack efficiency and reliability. For instance, they often require frequent file access to retrieve ground truth data, leading to increased resource consumption and difficulty in associating frames with their corresponding ground truth. To address these issues, the injection system 120 and/or the extraction system 140 can advantageously improve accuracy and resource efficiency by embedding ground truth data into the video frames as Supplemental Enhancement Information (SEI) messages and extracting this data during decoding, thus eliminating the need for separate file access.

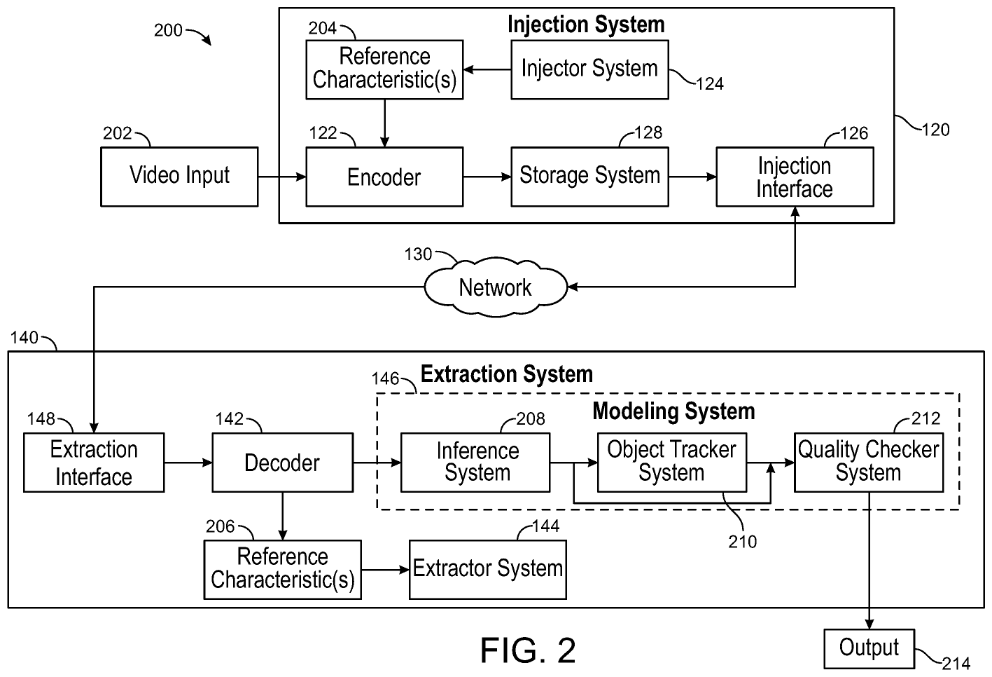

The video source 110 can be in communication with the injection system 120 and/or the extraction system 140 directly or indirectly via the network 130. The video source 110 can include one or more processors, circuits, memory, and/or computing devices/systems that can perform the various techniques described herein. The video source 110 can include any type of device that is capable of communicating via the network 130, including but not limited to smartphones, laptop or mobile computers, personal computers, servers, cloud computing systems, or other types of computing systems that can generate or otherwise provide one or more inputs (e.g., video input 202 of FIG. 2) to at least one injection system, such as the injection system 120. The video source 110 can include one or more communications interfaces that facilitate transmission of one or more network packets via the network 130 to one or more computing systems separate and/or remote from the video source 110, which can include the injection system 120 and/or the extraction system 140.

The video source 110 can generate video data (e.g., video input 202 of FIG. 2) and/or may correspond to video frames of a video stream generated from any suitable source, including a video playback process or a gaming process (e.g., video output from remotely executing video games), among other sources of video data. In some implementations, the video source 110 can execute one or more applications or games that generate the video data. The video source 110 can generate or otherwise capture uncompressed video content using high-definition cameras or other image capture devices. For instance, the video source 110 can output high-fidelity video streams that can serve as the input for an encoding process of the injection system 120. In some implementations, the video source 110 can generate or otherwise capture sequences of images for Motion JPEG (MJPEG) format, where each frame can be treated as an individual JPEG image.

The injection system 120 can be in communication with the video source 110 and/or the extraction system 140 directly or indirectly via the network 130. The injection system 120 can include one or more processors, circuits, memory, and/or computing devices/systems that can perform the various techniques described herein. The injection system 120 can include any type of device that is capable of communicating via the network 130, including but not limited to smartphones, laptop or mobile computers, personal computers, servers, cloud computing systems, and/or other types of computing systems that can receive or otherwise identify one or more inputs (e.g., video input 202 of FIG. 2) from the video source 110. The injection system 120 can also be and/or include any type of device that is capable of generating or otherwise providing encoded representations of image frames with inserted indications of reference characteristics to the extraction system 140. The injection system 120 can include one or more communications interfaces that facilitate transmission of one or more network packets via the network 130 to one or more computing systems separate and/or remote from the injection system 120, which can include the video source 110 and/or the extraction system 140. The injection system 120 described herein can be implemented, for example, in a cloud computing environment, which can maintain and execute encoding operations. As shown, the injection system 120 can include or couple with an encoder 122, an injector system 124, an injection interface 126, and a storage system 128. In some implementations, the injection system 120 can execute one or more of injection processes 204 of FIG. 2, and can communicate with one or more computing systems separate and/or remote from the injection system 120 that can execute extraction processes 206 of FIG. 2.

The injection system 120 can include or be coupled with at least one encoder, such as the encoder 122. The encoder 122 can encode (e.g., compress) video and image data, such as by using algorithms to reduce a file size of the video or image data. In some implementations, the encoder 122 can encode the input of video source 110 according to one or more parameters of encoding of the video data. For example, the encoder 122 can use one or more of the same encoding parameters (e.g., resolution, video file format) as the video data stored by the video source 110. In some embodiments, the encoder 122 can assign a flag to one or more parameters of the one or more vision models, the flag corresponding to a metric. For instance, the flag can be used to indicate encoding quality, error levels, etc. That is, the flag can facilitate the monitoring and managing of encoding performance. The encoder 122 can compress the bitstreams of the video or image data segment output by the video source 110. In some implementations, the encoder 122 can compress raw video content into formats suitable for storage and transmission, using standards like H.264, H.265 (HEVC), or VP9. In some implementations, the encoder 122 can compress each frame of an MJPEG into individual JPEG files. Compression can include reducing the file size while maintaining visual quality and facilitating the processing of high-resolution video inputs. The encoder 122 can output a compressed video stream which can be used to embed, insert, or otherwise include reference characteristics (e.g., ground truth (GT) data).

The encoder 122 can encode at least a subset of a plurality of frames (e.g., image frames) of a data segment (e.g., video data segment). The plurality of frames can include various types of frames, such as key frames and/or P-frames. A subset of the plurality of frames of the video data element can include one of a plurality of first frames that corresponds to the start position and each first frame of the plurality of first frames following the one of the plurality of first frames (e.g., start position) until the next key frame of the data segment. For example, the encoder 122 can encode a plurality of frames including a key frame that corresponds to the requested start position and can encode starting from the key frame until a boundary is met (e.g., another key frame). The encoder 122 can provide an output (e.g., encoded representation of frames with reference characteristics), including the plurality of frames to the storage system 128 (e.g., for storing the output) and/or to the injection interface 126 (e.g., to transmit to the extraction system 140, for example, over the network 130). In some implementations, the encoder 122 can use spatial compression to reduce redundancy between frames to reduce the file size. Additionally, or alternatively, the encoder 122 can use temporal compression to reduce the file size. Additionally, or alternatively, the encoder 122 can use motion estimation to encode motion vectors and reduce precision of the encoded video or image data.

The injection system 120 can include or be coupled with at least one injector system, such as the injector system 124. The injector system 124 can embed, insert, or otherwise include indications of reference characteristics into or with the encoded representation of frames generated by the encoder 122. For instance, the injector system 124 can read the raw video and associated reference characteristics, such as bounding boxes, class labels, and object IDs, and embed, insert, or otherwise include this data during or after the encoding process as messages, such as Supplemental Enhancement Information (SEI) messages. In some implementations, when MJPEG frames are received from the video source 110, the injector system 124 can insert reference characteristics using, for example, Application Markers (APP0-APPF) within the JPEG frames. In some implementations, when the data exceeds 16 bits, multiple markers may be used. The encoder 122 in combination with the injector system 124 is implemented to reduce or eliminate the need for separate file access during quality checks while improving frame associations with reference characteristics. For instance, the encoder 122 can embed or insert the indication of the reference characteristic into the encoded representation.

The system 100 can embed, insert, or otherwise include reference characteristics before, during, or after encoding operations. For example, the encoder 122 can first compress the video data, and then the injector system 124 can embed the reference characteristics as SEI messages during the encoding process. In another example, the encoder 122 can compress MJPEG frames, and the injector system 124 can insert reference characteristics using Application Markers within the JPEG frames after the compression. In some implementations, the injector system 124 may determine reference characteristics prior to the encoding process. The injector system 124 may be integrated within the encoder 122, or the encoder 122 may include one or more features and functionalities of the injector system 124. As shown, the combination of the encoder 122 and the injector system 124 facilitates embedding, insertion, or otherwise inclusion of reference characteristics.

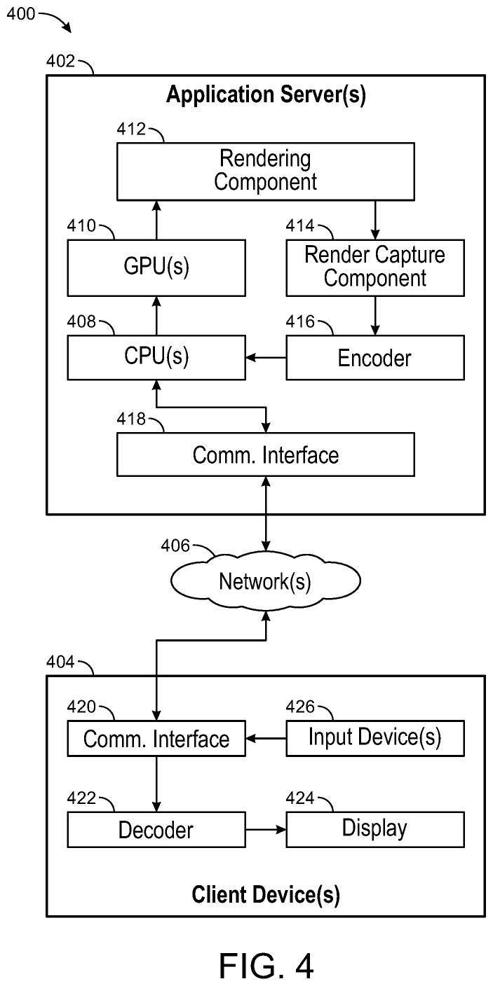

The injection system 120 can include or be coupled with at least one injection interface, such as the injection interface 126. The injection interface 126 can access the encoded representations of image frames (e.g., stored in storage system 128) and transmit (e.g., over network 130) the encoded representations in a network packet. In some implementations, the injection interface 126 may re-transmit one or more packets to the extraction system 140 upon receiving a request for transmission of packets from the extraction system 140 (e.g., if the packet was lost or corrupted during transmission). The injection interface 126 of the injection system 120 may include any of the structure of, and implement any of the functionality of, the communication interface 418 described in connection with FIG. 4. For instance, the injection interface 126 can transmit encoded video files over network 130 using a Real-Time Streaming Protocol (RTSP). The injection interface 126 can facilitate the streaming of multimedia content, ensuring the delivery of video data and embedded messages (e.g., embedded SEI message, collectively referred to as encoded representations of image frames with reference characteristics). The injection interface 126 can implement RTSP controls such as play, pause, and stop. The injection interface 126 can optimize video stream delivery to minimize latency and packet loss. In some implementations, the injection interface 126 can facilitate the streaming of MJPEG files, sending each JPEG frame with embedded reference characteristics over the network 130.

The injection system 120 can include or be coupled with at least one storage system, such as the storage system 128. The storage system 128 can store or otherwise maintain encoded video files and encoded MJPEG files, including those with embedded reference characteristics. In some implementations, the storage system 128 can facilitate storage operations such as data reads and writes. For instance, the storage system 128 can organize and index encoded files, facilitating access and management of the video and image data with embedded reference characteristics. In some implementations, the storage system 128 includes database functionalities to support query operations and metadata management for stored data. For instance, the storage system 128 can be an SQL database, a NoSQL database, buffer, or an object storage system. The storage system 128 can facilitate indexing, querying, and managing encoded data for data retrieval and storage.

The extraction system 140 can be in communication with the video source 110 and/or the injection system 120 directly or indirectly via the network 130. The extraction system 140 can include one or more processors, circuits, memory, and/or computing devices/systems that can perform the various techniques described herein. The extraction system 140 can include any type of device that is capable of communicating via the network 130, including but not limited to smartphones, laptop or mobile computers, personal computers, servers, cloud computing systems, and/or other types of computing systems that can receive or otherwise identify one or more inputs (e.g., encoded representations of image frames of FIG. 2) from the injection system 120. The extraction system 140 can also be and/or include any type of device that is capable of extracting or otherwise decompressing data received from the injection system 120 (e.g., encoded representations of an image frame that can include image frames and indications of reference characteristics of objects represented by the image frame). The extraction system 140 can include one or more communications interfaces that facilitate reception of one or more network packets via the network 130 from one or more computing systems separate and/or remote from the extraction system 140, which can include the video source 110 and/or the injection system 120. The extraction system 140 described herein can be implemented, for example, in a cloud computing environment, which can maintain and execute encoding operations. As shown, the extraction system 140 can include a decoder 142, an extractor system 144, a modeling system 146, and an extraction interface 148. In some implementations, the extraction system 140 can execute one or more of extraction processes 206 of FIG. 2, and can generate an output 214 of FIG. 2 that can be subsequently processed or otherwise used.

The extraction system 140 can include or be coupled with at least one decoder, such as the decoder 142. The decoder 142 can decode the video or image data (e.g., compressed video or image data; bitstream) retrieved or received by the extraction interface 148. The extraction interface 148 can provide the decoder 142 with, and without limitation, compressed video or image data (e.g., encoded representations of image frames), motion vectors, reference frame indices, and frame timestamps in separate bitstreams. That is, the extraction interface 148 can receive encoded representations of an image frame that can include image frames and indications of reference characteristics of objects represented by the image frame. The decoder 142 can convert and/or transform encoded representations into a format that can be modeled by or otherwise used by one or more computer vision models of the modeling system 146.

The decoder 142 can decode (e.g., decompress) frames included in the encoded representation structure including the reference characteristics (e.g., ground truth (GT) data). The decoder 142 may include, without limitation, any one or more of various types of video decoders (e.g., MPEG-4 Part 2, MPEG-4, H.264, H.265), image decoders (e.g., MJPEG, JPEG, PNG, GIF). The decoder 142 can apply reverse compression to the video data to reconstruct the frames for modeling (or display). The decoder 142 can compensate for motion vectors used in frames, for example, to reconstruct the frame. The decoder 142 can perform entropy decoding, inverse quantization, inverse transformation, and/or motion compensation to reconstruct the frames of the encoded representations. The decoder 142 can convert the bitstreams encoded in various formats to an acceptable format for the modeling system 146.

The extraction system 140 can include or be coupled with at least one extraction interface, such as the extraction interface 148. The extraction interface 148 can receive or otherwise identify encoded representations of image frames (e.g., provided or made available by injection interface 126 over network) and provide the encoded representations for decoding processes of extraction system 140. The extraction interface 148 of the extraction system 140 may include any of the structure of, and implement any of the functionality of, the communication interface 420 described in connection with FIG. 4. For instance, the extraction interface 148 receives encoded video files over network 130 using an RTSP. That is, the extraction interface 148 can maintain the integrity of the video stream and its embedded reference characteristics during transmission. In some implementations, the extraction interface 148 can facilitate the reception of individual JPEG frames with embedded reference characteristics. The extraction interface 148 can facilitate the reception and modeling of multimedia content.

The extraction system 140 can include or be coupled with at least one extractor system, such as the extractor system 144. The extractor system 144 can extract indications of reference characteristics from the encoded representation of frames. For instance, the extractor system 144 can read the encoded video and extract associated reference characteristics, such as bounding boxes, class labels, and object IDs, from messages like Supplemental Enhancement Information (SEI) messages. In some implementations, when MJPEG frames are received, the extractor system 144 can extract reference characteristics using, for example, Application Markers (APP0-APPF) within the JPEG frames. In some implementations, when the data exceeds 16 bits, multiple markers may be used. The decoder 142 in combination with the extractor system 144 is implemented to reduce or eliminate the need for separate file access during quality checks while accurately associating frames with reference characteristics.

The system 100 can perform extraction of reference characteristics before, during, or after decoding operations. For example, the decoder 142 can first decompress the video data, and then the extractor system 144 can extract the reference characteristics from SEI messages during the decoding process. In another example, the decoder 142 can decompress MJPEG frames, and the extractor system 144 can extract reference characteristics from Application Markers within the JPEG frames after decompression. In some implementations, the extractor system 144 may identify reference characteristics after the decoding process. The extractor system 144 may be integrated within the decoder 142, or the decoder 142 may include one or more features and functionalities of the extractor system 144. That is, the combination of the decoder 142 and the extractor system 144 facilitates extraction of reference characteristics.

As shown, the decoder 142 and/or extractor system 144 extract, from an encoded representation of an image frame, the image frame and an indication of a reference characteristic of one or more objects represented by the image frame. For instance, an encoded video stream can include SEI messages that include reference characteristics such as bounding boxes, class labels, and object IDs. In this instance, the extractor system 144 reads the SEI messages during the decoding process to retrieve these reference characteristics. In another instance, an encoded MJPEG stream includes Application Markers (APP0-APPF) within the JPEG frames that store reference characteristics. In this instance, the extractor system 144 parses these Application Markers after decompression to obtain the reference characteristics. In some implementations, the decoder 142 can receive the encoded representation as at least one of a stream of image data or compressed video data. For instance, the stream of image data can be received via RTSP over network 130. In another instance, the compressed video data can be stored in a file system (e.g., storage system 128) and accessed as needed for decoding and extraction.

The extraction system 140 can include or be coupled with at least one modeling system, such as the modeling system 146. The modeling system 146 can apply one or more artificial intelligence models, such as computer vision models, to decoded frames to generate inference data. The modeling system 146 can implement object detection and tracking, utilizing the metadata for model validation, and integrating with the decoded video stream. The modeling system 146 can process each frame, generating bounding boxes, class labels, and/or other relevant data, which is then compared with the embedded reference characteristics (e.g., metadata). In some implementations, the modeling system 146 can process each JPEG frame individually, applying similar inference and validation techniques as described with reference to the video and image frames above.

The modeling system 146 can track objects across video frames using inference data and metadata. The modeling system 146 can employ tracking that can assign unique identifiers (IDs) to objects, correlate object positions temporally, and update metadata with tracking information. The modeling system 146 can integrate with the inference output, maintaining continuity of object identification across frames. In some implementations, the modeling system 146 can track objects across individual JPEG frames. Furthermore, the modeling system 146 can model (or analyze) the performance of vision models by comparing inference data with metadata. For instance, the modeling system 146 can calculate quality metrics such as precision, recall, and Q scores, using comparison algorithms to report model accuracy of each of the one or more intelligence models individually or in combination. The comparison algorithms can be intersection over union (IoU) calculations, confusion matrix analysis, or any statistical performance measure relevant to the model. The modeling system 146 can use the embedded reference characteristics to perform deterministic quality evaluation. For MJPEG, the modeling system 146 can model (or analyze) each JPEG frame individually, facilitating metrics across the sequence of images. In some embodiments, the encoder 122 can assign a flag to one or more parameters of the one or more vision models, the flag corresponding to a metric (e.g., threshold value, quality score, processing status). That is, the flag can be used to indicate specific conditions or states for evaluation. For instance, the flag can signal when an object detection confidence score exceeds a certain threshold. In another instance, the flag can indicate when the processing status changes during model execution. In yet another instance, the flag can mark frames that require further review or validation.

In some implementations, the modeling system 146 can apply the image frame as the input to the one or more computer vision models by identifying the metadata in the buffer. That is, the decoder 142 can receive from a real-time stream (e.g., via extraction interface 148). The decoder 142 can extract the indication of the reference characteristic including extracting the message (e.g., having the GT data). The decoder 142 can store the GT data as metadata in a buffer corresponding with an extracted representation of the image frame. For instance, identifying the metadata in the buffer can include parsing the buffer to locate the reference characteristics. As shown, applying the image frame can include associating the frame data with its corresponding metadata for input to the vision models.

In some implementations, the modeling system 146 can determine a metric of operation of the one or more computer vision models, individually and/or in combination, based at least on the inference data and the reference characteristic. For instance, the modeling system 146 can compute a precision score by comparing detected objects against reference characteristics. In some implementations, the one or more computer vision models can include an object detector to assign a bounding box to a portion of the image frame corresponding to at least one object of the one or more objects detected by the object detector. For instance, the object detector can generate bounding boxes around detected vehicles in a traffic video. In some implementations, the one or more computer vision models can include an object tracker to generate the inference data to include an identifier to track the one or more objects across the image frame and a second image frame. For instance, the object tracker can follow a person moving through multiple camera frames. Additionally, the one or more computer vision models can be configured for face recognition, motion detection, or any other vision-based analysis. In some implementations, the modeling system 146 can determine a metric of operation of the one or more computer vision models, individually and/or in combination, based at least on the inference data and the reference characteristic. For instance, determining the metric of operation can be based on comparing the inference data with the reference characteristic. Comparing the inference data with the reference characteristic can include calculating the intersection over union (IoU) for bounding boxes, measuring classification accuracy, or any statistical comparison relevant to the specific vision model. Other comparison algorithms or techniques, such as such those evaluating the Mean Average Precision (mAP) or the Jaccard Index, are contemplated.

Now referring to FIG. 2, an example system 200 showing how indications of characteristics of one or more objects are injected and extracted is shown, in accordance with some embodiments of the present disclosure. The system 200 can include the injection system 120 and the extraction system 140, which can communicate directly or indirectly via the network 130. The injection system 120 can receive video input 202 from a video source (e.g., the video source 110). The video input 202 can be provided to the encoder 122, which compresses the video data into a suitable format for storage and transmission. The encoder 122 can receive reference characteristics 204, such as bounding boxes, class labels, and object IDs, which are embedded into the encoded representation of frames by the injector system 124. The injector system 124 inserts these reference characteristics during or after the encoding process as messages, such as Supplemental Enhancement Information (SEI) messages. When an MJPEG stream is being provided (e.g., as video input 202), reference characteristics can be inserted using Application Markers (APP0-APPF) within the JPEG frames. In some implementations, the encoded video data, now with embedded reference characteristics, can be stored in the storage system 128. The storage system 128 can organize and index encoded files, facilitating access and management of the video and image data. The injection interface 126 can access the encoded representations of image frames from the storage system 128 and transmit them over the network 130. The injection interface 126 can implement RTSP controls, such as play, pause, and stop, to optimize video stream delivery and minimize latency and packet loss.

In some implementations, the extraction system 140 receives the encoded video data via the extraction interface 148. The extraction interface 148 can maintain the integrity of the video stream and its embedded reference characteristics during transmission. The received encoded representations can be provided to the decoder 142, which can decompress the video data and can extract the embedded reference characteristics 206. The extracted reference characteristics 206 can be stored for further processing. In some implementations, the extractor system 144 can read the decoded video and can extract associated reference characteristics, such as bounding boxes, class labels, and object IDs, from SEI messages within image frames or Application Markers within JPEG frames. The decoder 142 and the extractor system 144 can perform operations in parallel or sequentially to reduce the need for separate file access during quality checks, accurately associating frames with reference characteristics. In some implementations, the modeling system 146 can apply vision models to the decoded frames to generate inference data. The modeling system 146 can include an inference system 208, an object tracker system 210, and a quality checker system 212. The inference system 208 can process the decoded frames and extracted reference characteristics. The object tracker system 210 can assign unique identifiers (IDs) to objects, can correlate object positions temporally, and can update metadata with tracking information. The quality checker system 212 can evaluate the performance of the vision models by comparing inference data with the embedded reference characteristics. For instance, the quality checker system 212 can calculate quality metrics such as precision, recall, and Q scores, using comparison algorithms to report model accuracy. As shown, the output 214 of the modeling system 146, which includes the evaluated performance metrics, can be generated for further use.

The inference system 208 of the modeling system 146 can process the decoded frames and extracted reference characteristics to generate inference data. For instance, the inference system 208 can apply one or more artificial intelligence models (e.g., one or more computer vision models) to the decoded frames, utilizing metadata for model validation. In some implementations, the inference system 208 can integrate inference data with the decoded video stream to maintain continuity and context. The inference system 208 can analyze each frame, generating relevant data such as bounding boxes and class labels. For instance, the inference system 208 can perform object detection and classification on each decoded frame, facilitating the alignment of the inference data with the reference characteristics.

The object tracker system 210 of the modeling system 146 can track objects across video frames using inference data and metadata. For instance, the object tracker system 210 can assign unique identifiers (IDs) to objects, facilitating the correlation of object positions temporally. In some implementations, the object tracker system 210 can update metadata with tracking information. The object tracker system 210 can integrate tracking data with the inference output to maintain the continuity of object identification. For instance, the object tracker system 210 can follow a moving object through multiple frames, updating its position and ID in the metadata.

The quality checker system 212 of the modeling system 146 can evaluate the performance of computer vision models by comparing inference data with the embedded reference characteristics. For instance, the quality checker system 212 can calculate quality metrics such as precision, recall, and Q scores using comparison algorithms. In some implementations, the quality checker system 212 can perform deterministic quality evaluation, providing metrics for model validation. The quality checker system 212 can analyze each frame individually. For instance, the quality checker system 212 can compare detected objects and their bounding boxes against the reference characteristics to measure the accuracy of the vision models.

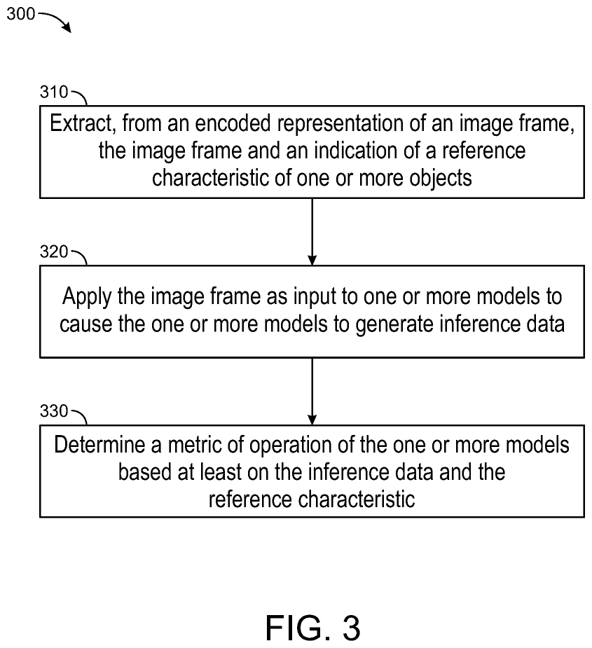

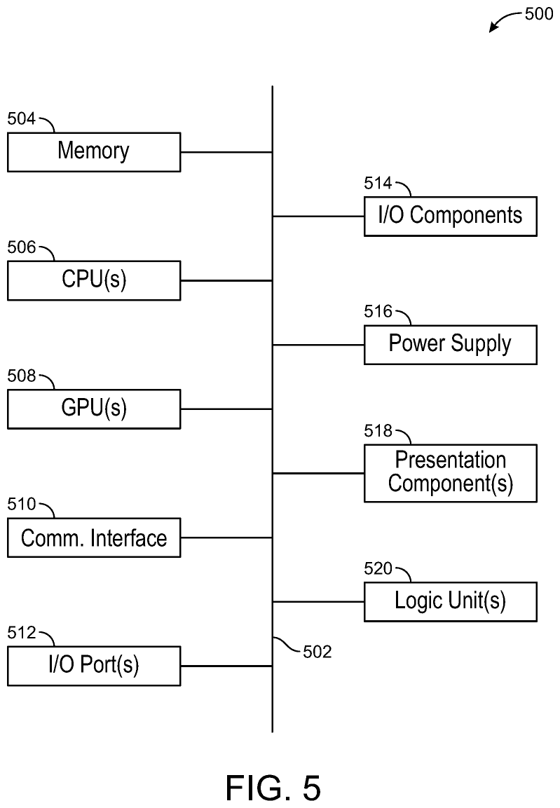

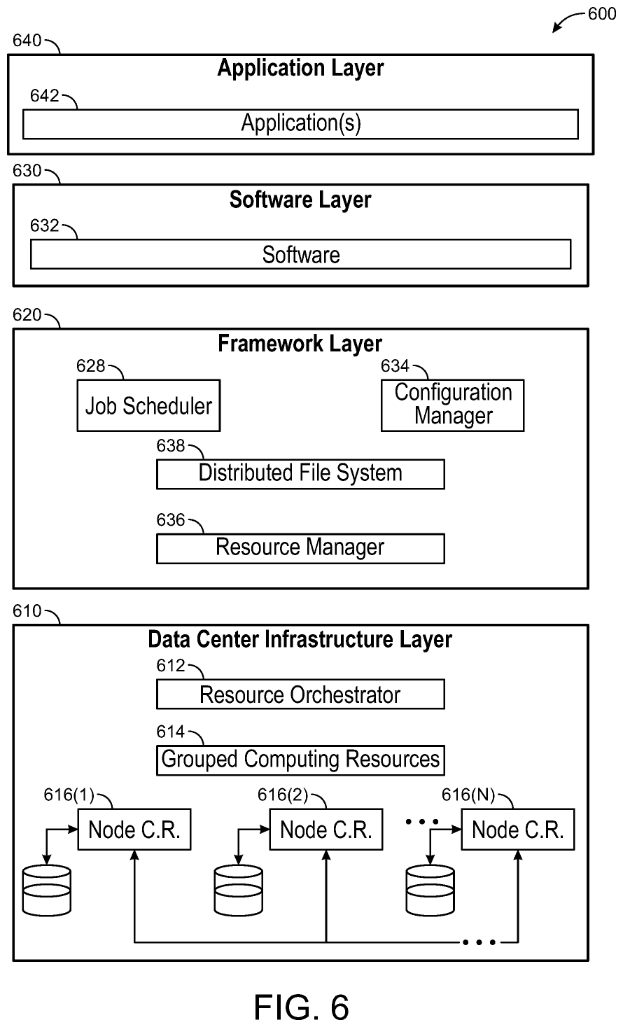

Now referring to FIG. 3, each block of method 300, described herein, includes a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 300 is described, by way of example, with respect to the systems and architectures of FIG. 1 and FIG. 2. However, this method can additionally or alternatively be executed by any one system, or any combination of systems, including, but not limited to, those described herein. For example, in some implementations, the systems and methods described herein may be implemented using one or more application servers and client devices (e.g., as described in FIG. 4), one or more computing devices (e.g., as described in FIG. 5), and/or one or more data centers (e.g., as described in FIG. 6).

FIG. 3 is a flow diagram showing a method 300 for performance monitoring of vision models, in accordance with some embodiments of the present disclosure. Various operations of the method 300 can be implemented by the same or different devices or entities at various points in time. For example, one or more first devices can implement operations relating to injection of indications of reference characteristics, and one or more second devices can implement operations relating to extraction of indications of reference characteristics.

Various operations of method 300 can relate to performance monitoring of vision models. Existing systems often are inefficient in the retrieval and use of ground truth data. The existing technological problems can arise when attempting to associate ground truth data with corresponding image frames during conditions such as frame drops or packet corruption. Method 300 and the systems and architectures of FIG. 1 and FIG. 2 can solve the technological problems by embedding ground truth data directly into the video frames, thereby reducing the need for separate file access and improving the reliability of frame-to-ground truth associations.

The method 300, at block 310, includes extracting, from an encoded representation of an image frame, the image frame and an indication of a reference characteristic of one or more objects represented by the image frame. For instance, a decoder can decode the encoded video stream to retrieve the image frame along with SEI messages including reference characteristics like bounding boxes, class labels, and object IDs. The extraction can be performed by a decoder, such as the decoder 142 of FIGS. 1-2. The decoder can decode the encoded image frame and/or MJPEG data to retrieve the image frame and the indication of the reference characteristic (e.g., ground truth (GT) data). For instance, the decoder can parse SEI messages embedded in the video stream to extract the GT data. In some implementations, one or more circuits (e.g., of the extraction system 140 of FIGS. 1-2) can receive the encoded representation as at least one of a stream of image data or compressed video data. For instance, the stream of image data can be transmitted via RTSP over a network (e.g., the network 130 of FIGS. 1-2).

In some implementations, one or more circuits (e.g., of the injection system 120 of FIGS. 1-2) can generate the encoded representation of the image frame using an encoder, such as encoder 122 of FIGS. 1-2. The encoder can be configured (e.g., programmed) to embed, insert, or otherwise include the indication of the reference characteristic into or with the encoded representation. For instance, the indication of the reference characteristic can be inserted as a supplemental enhancement information (SEI) message within the encoded representation of the image frame. The indication of the reference characteristic corresponds to ground truth (GT) data. For instance, the SEI message can include information about object positions, class labels, and other reference data. In some implementations, inserting the GT data can include embedding the GT data into the image frame of a plurality of image frames of a stream of image data or compressed video data. The GT data can include at least one of one or more bounding boxes, one or more class labels, or one or more object identifiers (IDs). That is, by integrating the GT data as SEI messages, the encoder can avoid using separate file access to retrieve GT information during quality checks (e.g., by the extraction system 140 of FIGS. 1-2). This can ensure that each frame is self-included with its corresponding GT data, providing improved reliability and resource-efficiency in evaluating model accuracy, for example, in the presence of frame drops and packet corruptions in streaming scenarios. The embedded GT data can be used by the decoder to extract and utilize the reference information directly from the video frames, improving the evaluation process and reducing the computational overhead associated with traditional methods that require frequent file I/O.

The method 300, at block 320, includes applying the image frame as input to one or more computer vision models to cause the one or more computer vision models to generate inference data regarding the one or more objects represented by the image frame. The computer vision models can be used to perform inference operations, such as, object detection, bounding box generation, and/or tracking. For instance, the computer vision models can analyze the decoded frames to identify and classify objects. The inference data can be the output of the computer vision models. In some implementations, the one or more computer vision models can include an object detector to assign a bounding box to a portion of the image frame corresponding to at least one object of the one or more objects detected by the object detector. For instance, the object detector can identify and outline vehicles in a traffic surveillance video. In some implementations, the one or more computer vision models can include an object tracker to generate the inference data to include an identifier to track the one or more objects across the image frame and a second image frame. For instance, the object tracker can follow a pedestrian moving across consecutive frames. In some implementations, applying the image frame as the input to the one or more computer vision models includes identifying the metadata in the buffer. For instance, the metadata extracted from SEI messages can be used to validate the vision model's inference data.

The method 300, at block 330, includes determining a metric of operation of the one or more computer vision models based at least on the inference data and the reference characteristic. For instance, determining the metric of operation can be based on comparing the inference data with the reference characteristic. The metrics can be performance metrics determined on the decoder side (e.g., by extraction system 140 of FIGS. 1-2) using the reference characteristic and the output of the computer vision model(s). For instance, the one or more circuits (e.g., of the extraction system 140) can calculate precision, recall, and other accuracy metrics by comparing the detected objects and their attributes against the ground truth data embedded in the frames.

In some implementations, the encoded representation can be received from a real-time stream (e.g., RTSP). Extracting the indication of the reference characteristic can include extracting the SEI message (also referred to as an SEI payload) including the GT data and storing (or attaching) the GT data as metadata in a buffer corresponding with an extracted representation of the image frame. In some implementations, the SEI payload can be processed to parse and extract ground truth data for each frame. For instance, the SEI messages can be decoded to retrieve bounding boxes, class labels, and other reference characteristics.

In some implementations, the encoded representation can be received via a Real-Time Streaming Protocol (RTSP) stream, and the one or more circuits (e.g., of the extraction system 140) can be configured to decode the stream, extract the SEI messages including the ground truth (GT) data, and store the extracted GT data as metadata associated with each image frame. This process ensures that the GT data remains accessible for downstream processing without requiring additional file access. By embedding the GT data in the video stream itself, the one or more circuits facilitate real-time evaluation of vision models even in the presence of network instability, as each frame carries its own reference data. The decoder processes the SEI messages alongside the video frames, attaching the GT data as metadata, which can then be used to validate inference results and track object characteristics throughout the stream. For instance, the one or more circuits can extract the SEI message including the GT data from the RTSP stream and store the GT data as metadata within a buffer associated with each decoded frame. In this instance, at block 330, the one or more circuits (e.g., of the extraction system 140) can use the GT data to validate the accuracy of computer vision models by comparing the model's inference results with the embedded reference data.

### Example Content Streaming System

Now referring to FIG. 4, FIG. 4 is an example system diagram for a content streaming system 400, in accordance with some embodiments of the present disclosure. FIG. 4 includes application server(s) 402 (which can include similar components, features, and/or functionality to the example injection system 120 or extraction system 140 of FIGS. 1-2), client device(s) 404 (which can include similar components, features, and/or functionality to the example computing device 500 of FIG. 5), and network(s) 406 (which can be similar to the network(s) described herein). In some implementations of the present disclosure, the system 400 can be implemented to perform model training/updating and runtime operations. The application session can correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations such as display or simulation operations.

In the system 400, for an application session, the client device(s) 404 can only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 can be displaying a frame of the application session on the display 424 based on receiving the display data from the application server(s) 402. The client device 404 can receive an input to one of the input device(s) and generate input data in response, such as to provide prompts as input for generation of 3D avatars. The client device 404 can transmit the input data to the application server(s) 402 via the communication interface 420 and over the network(s) 406 (e.g., the Internet-Web2 or Web3), and the application server(s) 402 can receive the input data via the communication interface 418. The CPU(s) can receive the input data, process the input data, and transmit data to the GPU(s) that causes the GPU(s) to generate a rendering of the application session. For example, the input data can be representative of a movement or animation of a character of the user in a game session of a game application, firing a weapon, reloading, passing a ball, turning a vehicle, etc. The rendering component 412 can render the application session (e.g., representative of the result of the input data) and the render capture component 414 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 402. In some implementations, one or more virtual machines (VMs)—e.g., including one or more virtual components, such as vGPUs, vCPUs, etc.—can be used by the application server(s) 402 to support the application sessions. The encoder 416 can then encode the display data to generate encoded display data and the encoded display data can be transmitted to the client device 404 over the network(s) 406 via the communication interface 418. The client device 404 can receive the encoded display data via the communication interface 420 and the decoder 422 can decode the encoded display data to generate the display data. The client device 404 can then display the display data via the display 424.

### Example Computing Device

FIG. 5 is a block diagram of an example computing device(s) 500 suitable for use in implementing some embodiments of the present disclosure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 can include one or more virtual machines (VMs), and/or any of the components thereof can include virtual components (e.g., virtual hardware components). For non-limiting examples, one or more of the GPUs 508 can include one or more vGPUs, one or more of the CPUs 506 can include one or more vCPUs, and/or one or more of the logic units 520 can include one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can be arranged in various topologies, including but not limited to bus, star, ring, mesh, tree, or hybrid topologies. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, quantum memories, or any other medium which can be used to store the desired information and which can be accessed by computing device 500. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In embodiments, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In embodiments, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 can include one or more data processing units (DPUs) to transmit data received over a network and/or through interconnect system 502 directly to (e.g., a memory of) one or more GPU(s) 508. In some implementations, a plurality of computing devices 500 or components thereof, which can be similar or different to one another in various respects, can be communicatively coupled to transmit and receive data for performing various operations described herein, such as to facilitate latency reduction.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user, such as to generate a prompt, image data, and/or video data. In some instances, inputs can be transmitted to an appropriate network element for further processing, such as to modify and register images. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one embodiments of the present disclosure, such as to implement the system 100 and/or the system 200 in one or more examples of the data center 600. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one embodiment, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-616(N) can include one or more virtual components, such as vGPUs, vCPUs, and/or the like, and/or one or more of the node C.R.s 616(1)-616(N) can correspond to a virtual machine (VM).

In at least one embodiment, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one embodiment, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one embodiment, resource orchestrator 612 can include a software design infrastructure (SDI) management entity for the data center 600. The resource orchestrator 612 can include hardware, software, or some combination thereof.

In at least one embodiment, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can utilize distributed file system 638 for large-scale data processing (e.g., “big data”). In at least one embodiment, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one embodiment, clustered or grouped computing resources can include grouped computing resource 614 at data center infrastructure layer 610. The resource manager 636 can coordinate with resource orchestrator 612 to manage these mapped or allocated computing resources.

In at least one embodiment, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one embodiment, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments, such as to train, configure, update, and/or execute machine learning models.

In at least one embodiment, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train/update one or more machine learning models (e.g., train/update machine learning models) or predict or infer information using one or more machine learning models (e.g., to generate a large language model) according to one or more embodiments described herein. For example, a machine learning model(s) can be trained/updated by calculating weight parameters according to a neural network architecture using software and/or computing resources described above with respect to the data center 600. In at least one embodiment, trained/updated or deployed machine learning models corresponding to one or more neural networks can be used to infer or predict information using resources described above with respect to the data center 600 by using weight parameters calculated through one or more training/updating techniques, such as but not limited to those described herein.

In at least one embodiment, the data center 600 can use CPUs, application-specific integrated circuits (ASICs), GPUs, FPGAs, and/or other hardware (or virtual compute resources corresponding thereto) to perform training/updating and/or inferencing using above-described resources. Moreover, one or more software and/or hardware resources described above can be configured as a service to allow users to train/update or perform inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, a holographic display, a biometric authentication device, a quantum computing device, a neuroenhancement headset, an augmented reality glasses, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
extract, from an encoded representation of an image frame, the image frame and an indication of a reference characteristic of one or more objects represented by the image frame;
apply the image frame as input to one or more vision models to cause the one or more vision models to generate inference data regarding the one or more objects represented by the image frame; and
determine a metric of operation of the one or more vision models based at least on the inference data and the reference characteristic.

2. The one or more processors of claim 1, wherein the one or more circuits are to receive the encoded representation as at least one of (i) a stream of image data or (ii) compressed video data.

3. The one or more processors of claim 1, wherein the one or more vision models comprise at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame.

4. The one or more processors of claim 1, wherein the one or more circuits are to determine the metric of operation based at least on comparing the inference data with the reference characteristic.

5. The one or more processors of claim 1, wherein the one or more circuits are to at least one of (i) assign a flag to one or more parameters of the one or more vision models, the flag corresponding to the metric, or (ii) update the one or more parameters based at least on the metric.

6. The one or more processors of claim 1, wherein the one or more circuits are to generate the encoded representation of the image frame using an encoder, wherein the encoder is configured to insert the indication of the reference characteristic into the encoded representation.

7. The one or more processors of claim 6, wherein the encoder is configured to insert the indication of the reference characteristic as a supplemental enhancement information (SEI) message within the encoded representation of the image frame, and wherein the indication of the reference characteristic corresponds to ground truth (GT) data.

8. The one or more processors of claim 7, wherein inserting the GT data comprises embedding the GT data into the image frame of a plurality of image frames of a stream of image data or compressed video data, and wherein the GT data comprises at least one of one or more bounding boxes, one or more class labels, or one or more object identifiers (IDs).

9. The one or more processors of claim 7, wherein the encoded representation is received from a real-time stream, and wherein extracting the indication of the reference characteristic comprises extracting the SEI message comprising the GT data and storing the GT data as metadata in a buffer corresponding with an extracted representation of the image frame.

10. The one or more processors of claim 9, wherein applying the image frame as the input to the one or more vision models comprises identifying the metadata in the buffer.

11. The one or more processors of claim 1, wherein the one or more processors are comprised in at least one of:
a system for generating synthetic data;
a system for performing simulation operations;
a system for performing digital twin operations;
a system for performing conversational AI operations;
a system for performing deep learning operations;
a system for performing collaborative content creation for 3D assets;
a system comprising one or more large language models (LLMs);
a system comprising one or more vision language models (VLMs);
a system for performing light transport simulation;
a system incorporating one or more virtual machines (VMs);
a system implemented using an edge device;
a system implemented using a robot;
a control system for an autonomous or semi-autonomous machine;
a perception system for an autonomous or semi-autonomous machine;
a system implemented at least partially in a data center; or
a system implemented at least partially using cloud computing resources.

12. A system comprising:
one or more processors to execute operations comprising:
extract, from an encoded representation of an image frame, the image frame and an indication of a reference characteristic of one or more objects represented by the image frame;
apply the image frame as input to one or more vision models to cause the one or more vision models to generate inference data regarding the one or more objects represented by the image frame; and
determine a metric of operation of the one or more vision models based at least on the inference data and the reference characteristic.

13. The system of claim 12, wherein the one or more processors executing the operations are to receive the encoded representation as at least one of (i) a stream of image data or (ii) compressed video data.

14. The system of claim 12, wherein the one or more vision models comprise at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame.

15. The system of claim 12, wherein the one or more processors executing the operations are to determine the metric of operation based on comparing the inference data with the reference characteristic, and wherein the one or more processors executing the operations are to at least one of (i) assign a flag to one or more parameters of the one or more vision models, the flag corresponding to the metric, or (ii) update the one or more parameters based at least on the metric.

16. The system of claim 12, wherein the one or more processors executing the operations are to generate the encoded representation of the image frame using an encoder, wherein the encoder is configured to insert the indication of the reference characteristic into the encoded representation.

17. The system of claim 12, wherein the encoder is to insert the indication of the reference characteristic as a supplemental enhancement information (SEI) message within the encoded representation of the image frame, and wherein the indication of the reference characteristic corresponds to ground truth (GT) data, and wherein inserting the GT data comprises embedding the GT data into the image frame of a plurality of image frames of a stream of image data or compressed video data, and wherein the GT data comprises at least one of one or more bounding boxes, one or more class labels, or one or more object identifiers (IDs).

18. The system of claim 17, wherein the encoded representation is received from a real-time stream, and wherein extracting the indication of the reference characteristic comprises extracting the SEI message comprising the GT data and storing the GT data as metadata in a buffer corresponding with an extracted representation of the image frame, and wherein applying the image frame as the input to the one or more vision models comprises identifying the metadata in the buffer.

19. A method, comprising:
extracting, using one or more processors from an encoded representation of an image frame, the image frame and an indication of a reference characteristic of one or more objects represented by the image frame;
applying, using the one or more processors, the image frame as input to one or more vision models to cause the one or more vision models to generate inference data regarding the one or more objects represented by the image frame; and
determining, using the one or more processors, a metric of operation of the one or more vision models based at least on the inference data and the reference characteristic.

20. The method of claim 19, further comprising:
receiving, using the one or more processors, the encoded representation as at least one of (i) a stream of image data or (ii) compressed video data;
wherein the one or more vision models comprise at least one of (i) an object detector to assign a bounding box to a portion of the image frame corresponding to at least one object of the one or more objects detected by the object detector or (ii) an object tracker to generate the inference data to include an identifier to track the one or more objects across the image frame and a second image frame.
